(19) United States
(12) Patent Application Publication
(10) Pub. No.: US 2009/0106984 A1
(43) Pub. Date: Apr. 30, 2009

(54) Measuring scissors

(76) Inventor: Walter David Braswell, Goose Creek, SC (US)

Correspondence Address: Walter David Braswell, 103 Cumberland Court, Goose Creek, SC, 29445, US

(21) Appl. No.: 11/978,884

(22) Filed: Oct. 30, 2007

(51) Int. Cl. B26B 13/00

(52) U.S. Cl. 30/254; 30/233; 30/257

(57) ABSTRACT

A hand-held scissors for measuring and cutting fabric or other material includes: (a) a pair of cooperating, cross-connected levers movably joined at a fulcrum, each lever including a handle member on one side of the fulcrum, and a blade member on an opposite side of the fulcrum, each blade member including one elongated cutting edge, the cutting edges facing one another, a first one of the substantially ring-shaped handle members including a first handle hole, and a second one of the handle members including a second handle hole, each blade member including a substantially planar upper surface and a substantially planar opposite, lower surface, and (b) a set of measurement indicia permanently marked on the upper surface of a blade member, and the lower surface of a blade member.

### BACKGROUND OF THE INVENTION

1. Technical Field

The present invention relates to a hand-held scissors for measuring and/or cutting a sheet material or other surface.

2. Background Information

A person using a pair of scissors must often stop and search the house, schoolroom, or office for a ruler, tape measure, protractor, or the like, and a marking instrument in order to measure and mark whatever sheet material is to be cut. Then the user must measure and mark the sheet material, pick up the scissors and begin cutting, put down the scissors to measure again, and so forth.

Using the measuring scissors of the present invention, a user can both cut and measure sheet material or other surface without having to stop and search for a separate measuring tool. The measuring scissors of the present invention include measurement markings, preferably using standard measurements (e.g., inches, eighths of an inch), and/or the metric system (e.g., millimeters, centimeters), on the interior and/or exterior side of either blade or both blades. The measuring scissors of the present invention permit cutting and measuring of dimensions without the use of separate external measuring tools and marking devices. The measurement indicia of the present invention may be on the interior side of the lower blade, or the exterior side of either blade, for use in the extended/open or engaged/closed scissors position.

The measuring scissors of the present invention may be sized for adult use, or they may be child's safety scissors. The child's safety scissors of the present invention is useful as a teaching tool where, for example, one side of the blade is marked in metric increments, while the opposite side of the blade is marked in inches and fractions of an inch.

### BRIEF SUMMARY OF THE INVENTION

The present invention is a hand-held scissors for measuring a substantially planar surface, preferably a sheet material to be cut, comprising: (a) a pair of cooperating, cross-connected levers movably joined at a fulcrum, each lever comprising a handle member on one side of the fulcrum, and a blade member on an opposite side of the fulcrum, each blade member comprising one elongated cutting edge, the cutting edges facing one another, a first one of the substantially ring-shaped handle members comprising a first handle hole, and a second one of the handle members comprising a second handle hole, each blade member comprising a substantially planar upper surface and a substantially planar opposite, lower surface, and (b) a set of measurement indicia permanently marked on the upper surface of at least one of the blade members, and the lower surface of at least one of the blade members. The measurement indicia may be English system or metric system markings, and/or angle markings. The measuring scissors may also include a file on an upper surface of a blade member, and/or magnetic tip portions on the tips of the measuring scissors. The measuring scissors is also useful as a teaching tool for teaching the metric system versus the English system to children or adults.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is an elevational view of a measuring scissors according to the present invention, shown in an open position;

FIG. 2 is an elevational view of an opposite side of the measuring scissors of FIG. 1, showing closed scissors with a file;

FIG. 3 is an elevational view of an opposite side of the measuring scissors of FIG. 1, showing closed scissors;

FIG. 4 is an elevational view of a measuring scissors according to the present invention, showing closed scissors with a turning notch;

FIG. 5 is an elevational view of a measuring scissors according to the present invention, showing open scissors with angle markings;

FIG. 6 is an elevational view of a measuring scissors according to the present invention, shown in an open position;

FIG. 7 is an elevational view of a measuring scissors according to the present invention, showing open scissors with a file;

FIG. 8 is an elevational view of a measuring scissors according to the present invention, showing closed scissors with tip magnets;

FIG. 9 is an elevational view of a child's safety measuring scissors according to the present invention, shown in an open position;

FIG. 10 is an elevational view of a child's safety measuring scissors according to the present invention, shown in an open position; and

FIG. 11 is an elevational view of a child's safety measuring scissors according to the present invention, shown in an open position.

### DETAILED DESCRIPTION OF THE INVENTION

In the following description, like reference characters designate like or corresponding parts throughout the several views. Also, in the following description, it is to be understood that such terms as “top” and “bottom” and the like are words of convenience and are not to be construed as limiting terms. Referring in more detail to the drawings, the invention will now be described.

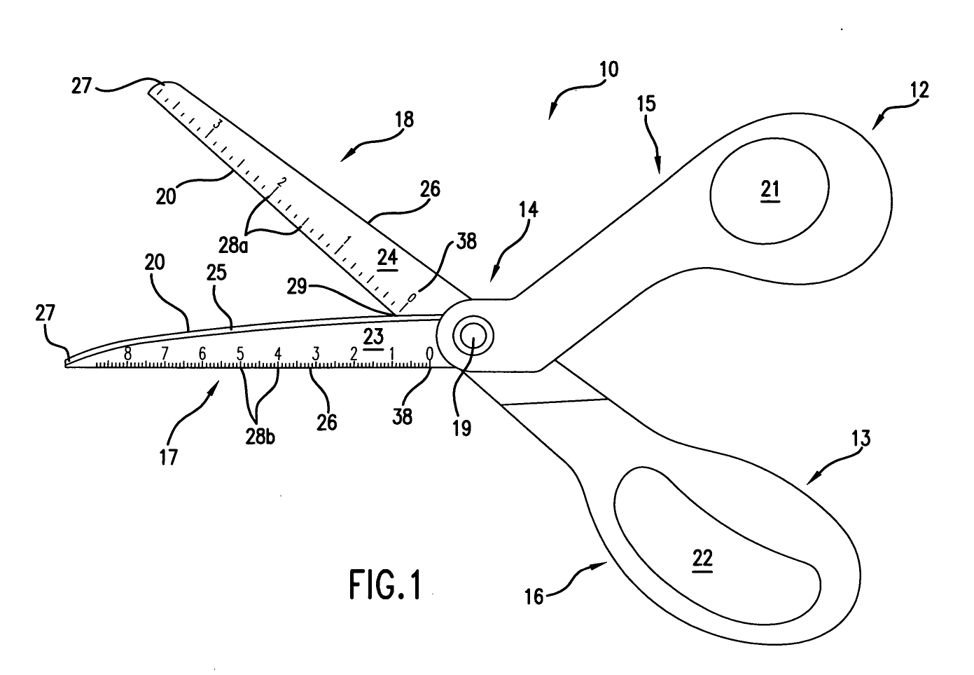

Turning first to FIGS. 1 through 3, a measuring scissors 10 according to the present invention includes two blade members 17, 18 with measurement markings 28 for measuring and cutting fabric or any other suitable material 11 without having to halt work to find a separate ruler. The measuring scissors 10 is two tools in one: a ruler and a cutting implement.

In general, the hand-held measuring scissors 10 includes a pair of cooperating first and second levers 12, 13 joined at a fulcrum 14. The movable, cross-connected levers can be joined together by a fulcrum nut and bolt assembly or rivet assembly. Each lever 12, 13 includes a handle member 15, 16 on one side of the fulcrum, and a blade member 17, 18 on the other side of the fulcrum. The two levers 12, 13 rotate about an axis of rotation 19 at the fulcrum. A cutting plane of the levers 12, 13 is substantially perpendicular to the fulcrum axis of rotation 19.

One elongated edge of each blade member 17, 18 is a relatively sharp cutting edge 20. The cutting edges 20 of the blade members 17, 18 in a pair of scissors 10 face one another as seen in FIG. 1, so as to be able to cut through the desired material. The cutting edges 20 of the levers cut the sheet material 11 or other surface as they come together. The upper and lower surfaces 23, 24 of the blade members 17, 18 are substantially planar. The hand-held measuring scissors 10 are for measuring and/or cutting a material 11 on or near which they are positioned, and are especially intended for school, office, or household (e.g., crafts) use.

Referring to FIG. 1, each blade member 17, 18 has a set of measurement indicia 28 permanently marked on the upper surface 23 and/or the lower surface of the blade member 17, 18. The measurement indicia 28, or markings, marked on the surfaces of the blade members 17, 18 may be the same as one another, or different. In FIG. 1, English system length markings 28a are marked on the lower surface 24 of the second blade member 18 of the scissors 10. Metric system length markings 28b are marked on the upper surface 23 of the first blade member 17 in FIG. 1. The two measurement systems facilitate use by different users who prefer one system of measurement over another, or by a user who wishes to compare or switch between one system of measurement and the other. Any suitable method of printing the measurement indicia 28 on the blade member 17, 18 may be used.

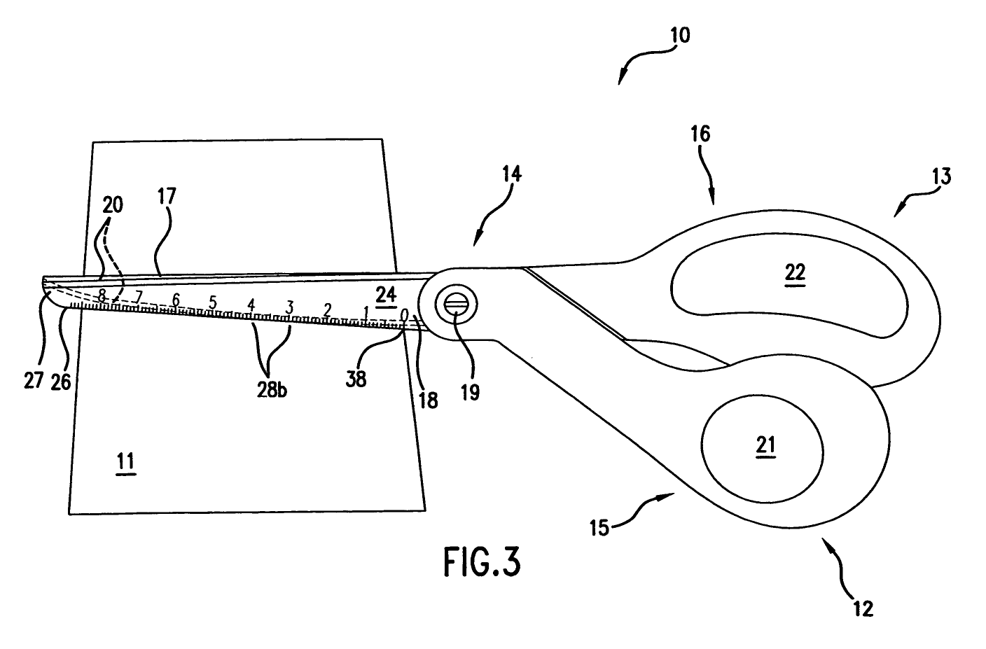

As seen in FIGS. 1 and 3, the measurement indicia 28 start with “0” on the end of the blade members 17, 18 closest to the fulcrum 14. As has been found herein, this is so the measurement markings 28 are helpful to the user as the fabric or other surface 11 is being cut, since the user is looking down the scissors 10 from the handle end of the scissors. On the lower surface 24, the “0” numeral marking 38 is preferably placed (and the markings start) at the apex 29, or juncture, of the cutting edges 20 as shown in FIG. 1. It has been found herein that this is an optimal location for the markings 28 to begin because a user's scissors 10 are usually at this approximately 45 degree angle when cutting is initiated. The markings 28 on the upper surface 23 of the blade member also begin with “0” on the end of the blade member that is closest to the handle member and the fulcrum 14.

It has also been found herein that the markings 28 on the lower surface 24 should be set off from the cutting edge 20 slightly, as seen in FIGS. 1 and 3, because offset markings 28 are easier to see while cutting, and so that engraving or other marking indentations do not interfere with the cutting edge 20. However, on the upper surface 23 of the blade members 17, 18 as seen in FIGS. 1 and 3, the markings 28 are preferably located directly on the outside edge 26 of the blade member. It has been found herein that it is easier to take a measurement using the outside (ruler) edge 26 when the markings 28 are on the outside edge 26, which is not a cutting edge.

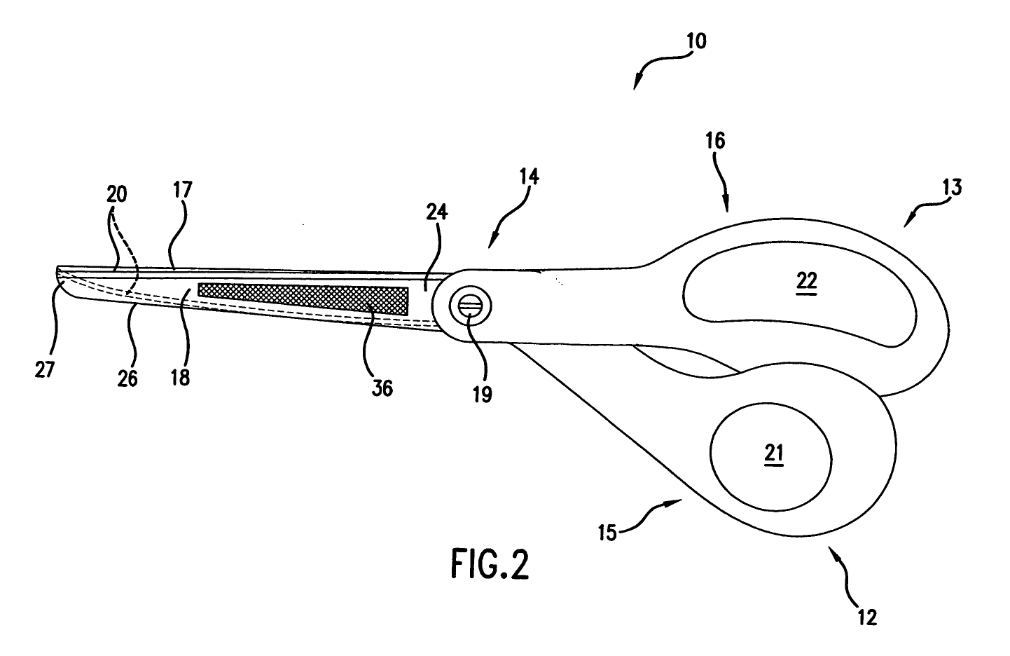

When the measuring scissors 10 are in a closed position as seen in FIG. 2, the lower (bottom) surfaces 24 of the two blade members 17, 18 substantially overlie one another and are largely not seen. The opposite side of the scissors 10 depicted in FIG. 1 is shown in FIGS. 2 and 3. When the scissors 10 are closed, an upper (top) surface 23 of a blade member is visible to the user. When the closed pair of scissors 10 is flipped over, the other upper surface 23 is visible. One elongated inside cutting side of each blade member preferably slopes down at about a 45° angle, or slope 25, to the cutting edge 20, as seen in FIG. 1. The sloped edge 25 is only on one side of each blade member; the other side is planar. The opposite elongated edge 26 of each blade member is preferably substantially straight and planar, although it preferably curves in slightly toward the cutting edge 20 on its tip portion 27. The “inside’ cutting edges 20, which are between the blade members of the scissors, face one another, while the opposite, substantially straight long edges 26 of each blade member are on the outside of the blade members, or scissors, facing away from one another, as seen in FIG. 2.

An upper surface 23 of the blade member 18 may include a file 36, as seen in FIG. 2, or a third set of measurement markings 28, as seen in FIG. 3. A set of metric system measurement markings 28b, for example, is shown in FIG. 3. The “0” numeral marking 38 is at the end of the blade member that is closest to the fulcrum 14, and the measurement ticks are on the substantially straight edge 26 (see FIGS. 1 and 3). Where the upper surface 23 of the second blade member 18 includes a third set of measurement markings 28, the upper surface 23 of the first blade member 17 can include a fourth set of measurement indicia 28, if desired.

The file 36 can be engraved on a portion of the upper surface 23 of one or both of the blade members 17, 18, as seen in FIG. 2. To use the file, the scissors 10 can be grasped in the user's hand and the exposed top surface of the file 36 is scraped back and forth across the surface to be filed, such as metal items used in crafts, etc. Thus, the scissors 10 shown in FIGS. 1 and 2 functions as three tools in one: a ruler, a file, and a cutting tool.

The handle members 15, 16 of the scissors herein may have any suitable shape. As shown in FIG. 1, the first handle member 15 is angled at an obtuse angle with respect to the first blade member 17 in the scissors. The second handle member 16, though, is preferably in line with the second blade member 18, and is not angled with respect to the second blade member. A first one of the substantially ring-shaped handle members 17 includes a first handle hole 21 for receiving the user's thumb, and a second handle member 18 includes a second handle hole 22 for receiving the user's first three fingers of the same hand. The handle holes 21, 22 may be the same size, though the second handle hole 22 is preferably larger and more oval-shaped than the more preferred circular-shaped first handle hole 21. The measuring scissors 10 may be made for a right handed user, a left handed user, or for both left and right handed users. Each handle member 15, 16 preferably includes a similarly-shaped handle grip closely fitted thereon. Preferably, the handle members 17, 18 are made of plastic and the blade members 17, 18 are made of stainless steel or another suitable sturdy material for cutting.

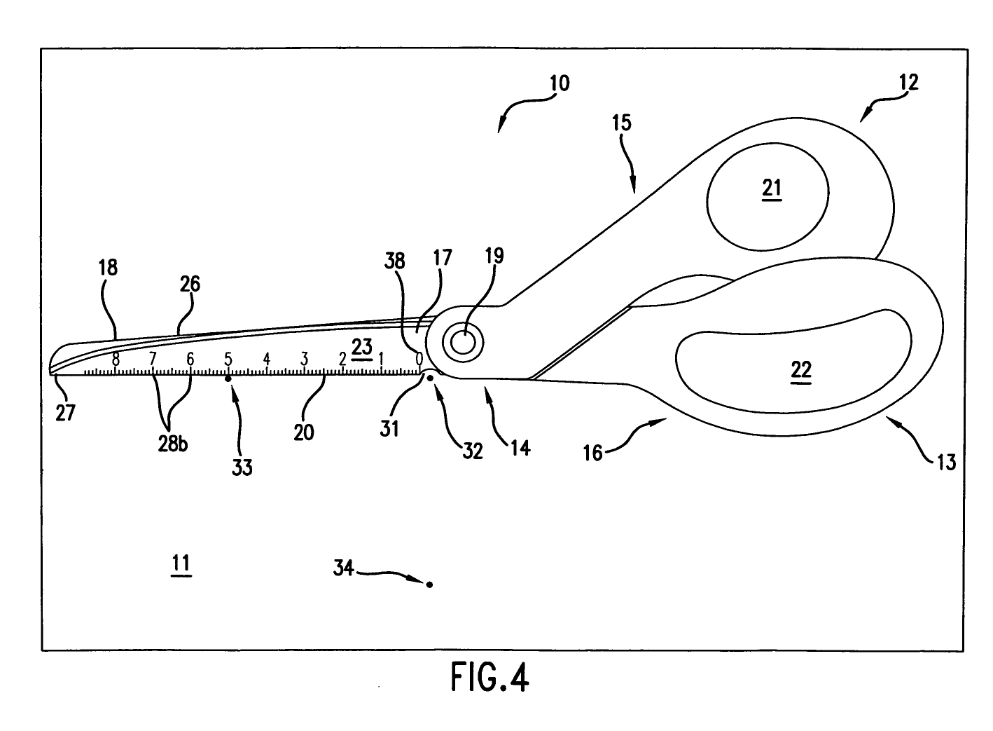

Turning now to FIG. 4, the measuring scissors 10 may further include a semi-circular shaped turning notch 31 in the outside edge 26 adjacent or on the “0” numeral marking 38 on the upper surface 23. A seamstress or other user often uses a marking implement, such as a pencil, chalk, or marker, to mark a desired measurement before or during the cutting process. To use the turning notch 31, the user lays the scissors down in a first position on the fabric or other material 11 to be measured, and places the tip of the marking implement point down in the notch 31. The user can then mark the “0” marking with a first dot as seen in FIG. 4 at 32, trace along the outside edge and then place a second dot 33 at the desired marking, such as the 5 centimeter mark as seen in FIG. 4. Furthermore, the user can place the tip of the marker in the turning notch 31 perpendicular to the scissors 10 and turn the scissors with the other hand, as indicated by the arrow, to a desired angle in relation to the first position, then mark another marking dot 34 (e.g., at 5 centimeters) on the fabric 11.

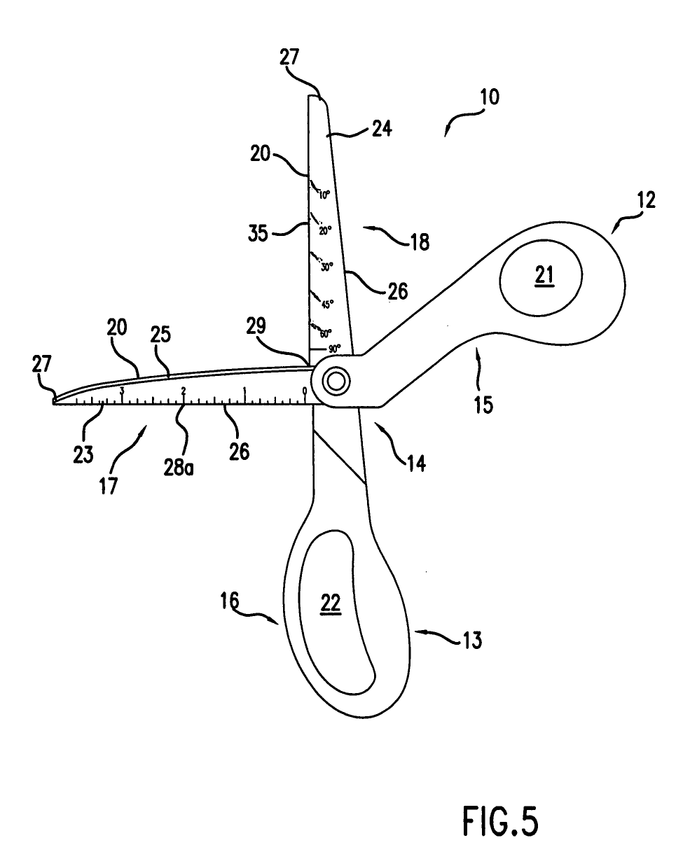

Turning to FIG. 5, the measurement indicia 28 may alternatively include angle markings 35 marked on the lower surface 24 of the blade members 17, 18 adjacent the cutting edge 20 for measuring or marking angles on the fabric, paper, or other surface 11 below the scissors 10. On the scissors 10 depicted in FIG. 5, the “90°” marking is placed closest to the apex 29 of the first and second blade members. The marking associated with the numeral “90°” is preferably substantially perpendicular to the cutting edge 20. Each time the cutting edge 20 of the second blade member 18 is placed over the 90° marking, the two blade members 17, 18 form a right angle. A right angle can then be drawn on the paper or other surface 11 by tracing the cutting edges 20. Next to the 90° mark, a 60° mark, or 45° mark (indication) is marked on the lower surface 24 of the blade member, and so forth, with as many angle indications as can practically fit on the blade member. The angle markings 35 other than the 90° marking are slanted, or angled, with regard to the cutting edge 20 on which they are placed as seen in FIG. 5. The angle markings 35 can range between zero and 180°, preferably 10°, 20°, 30°, 45°, 60°, and/or 90° markings. If the cutting edge 20 of the second blade member 18 is positioned, for example, on the 45 degree angle marking, the two blade members 17, 18 form approximately a 45 degree angle (see the angle of the blades in FIG. 1).

If desired, the user places the blade members in position and then traces the desired angle along the cutting edges 20 using a marker. Alternatively, the user uses a marker to place dots on the fabric 11, and then cuts the fabric using the scissors 10. Thus, the measuring scissors 10 functions as a limited protractor, a ruler, and a cutting implement, all in one tool. The scissors may also include a fourth function: a file 36. Once the blade members are placed in position at the desired angle using the angle markings 28, the user can also tilt the measuring scissors 10 up so that its longitudinal axis is substantially perpendicular to the sheet of paper or other surface 11 and use the scissors 10 as a compass (a fifth function). A pencil or the like can be used to mark the place where the tip of the blade member contacts the paper (e.g., to mark an arc). The notch 31 can also be used in conjunction with the angle markings 35.

Continuing with FIG. 5, the upper surface 23 of the second blade member 18 may include markings 28 for measuring lengths. The desired length and angle of the material to be cut are measured using the measurement indicia 28 on the upper surface 23, and/or the angle indicia 31 on the lower surface 24, respectively, of one or both blade members 17, 18.

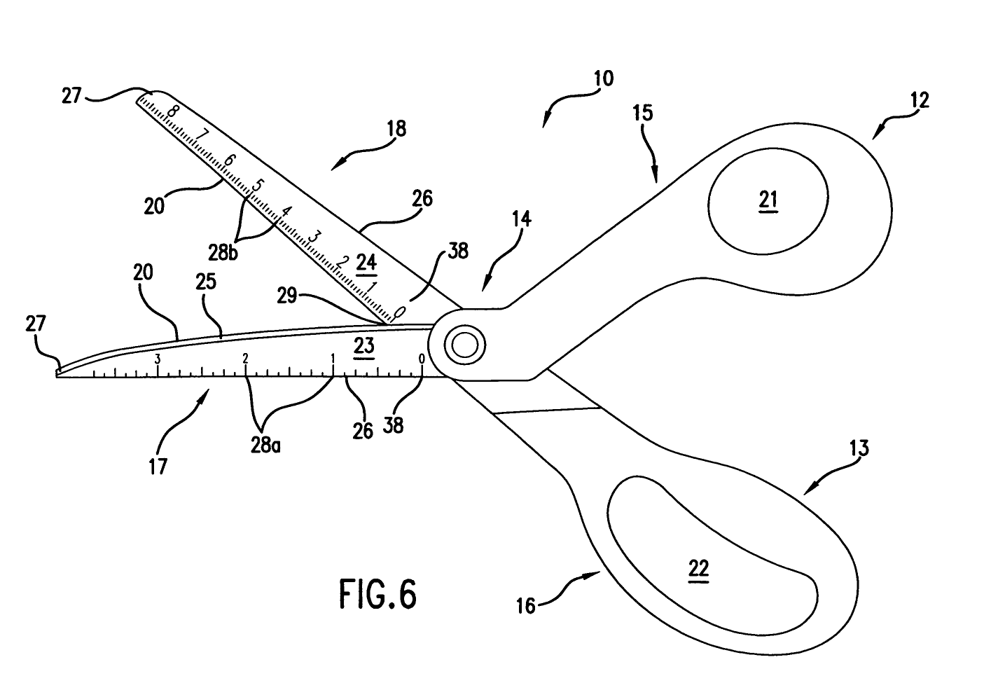

In the measuring scissors 10 illustrated in FIG. 6, English system length indicia 28a are on the outside, straight edge 26 of the upper surface 23 of the first blade member 17, with the “0” marking 38 close to the fulcrum 14. Here, the English system numeral markings on the upper surface 23 (here, 1, 2, and 3 inches) face away from the straight edge 26 so they can be read as the scissors lies on the surface 11 to be measured. Continuing with FIG. 6, metric system indicia 28b are etched on the lower surface 24 of the second blade member 18, with the “0” marking 38 near the apex 29, or juncture, of the two blade members.

The metric system numeral markings 28b on the lower surface 24 face the cutting edge 20 of the blade member, so they can easily be read as the scissors cuts the fabric or other material 11. Since the measures are displayed side by side on the scissor blades, this pair of scissors 10 is an effective tool for teaching the metric system versus the English length measurement system. The English system numerals on one blade member face in an opposite direction than the metric system numerals on the other blade member, since the two sets of indicia 28 are used in different ways. Alternatively, the same set of measurements 28 can be printed on both blade members (inches, for example), or measurement indicia 28 may be printed on one of the blade members of a pair of scissors, but not on the other. The numerals of the measurement markings 28 are substantially horizontally oriented on the outside edge 26 of the blade, as seen in FIG. 6, so that they are easy to read when the measuring scissors 10 are held in a sideways position (horizontally) for measuring.

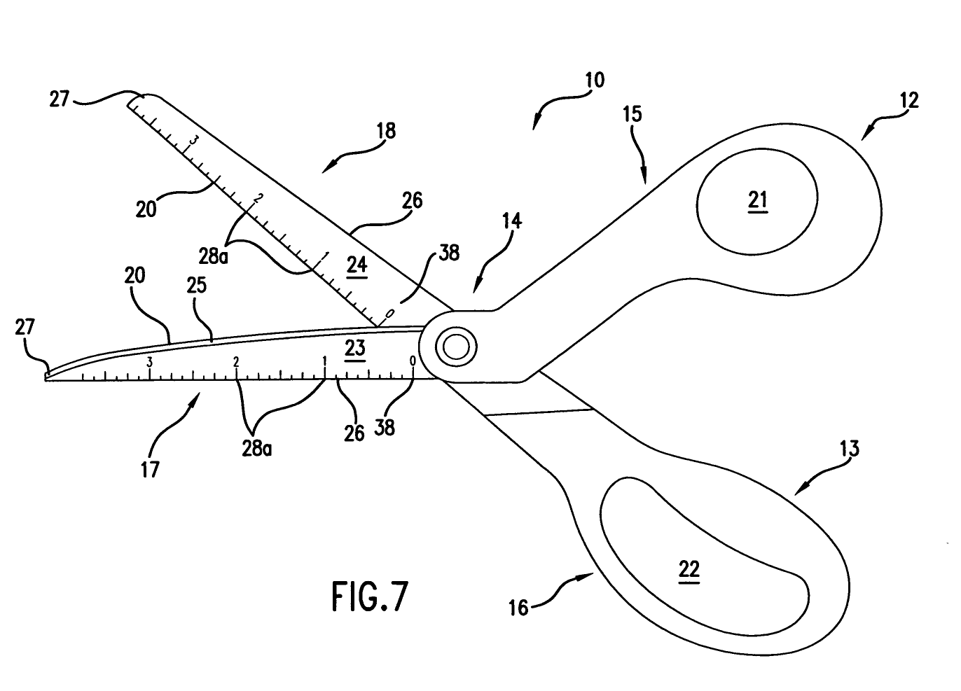

In the measuring scissors of FIG. 7, two sets of English system indicia 28a is engraved on the lower surface 24 of the second blade member 18 and the upper surface 23 of the first blade member 17. Metric system indicia 28 can alternatively be printed on the lower surface 24 of the first blade member 17, or on the upper surface 23 of the other, second blade member 18. In any pair of scissors 10 herein, the numeral markings (e.g., 0, 1, 2, 3) can be substantially vertically oriented (sideways) along the longitudinal axis of the blade member, as seen in FIG. 7. It has been found herein that substantially vertically oriented numeral markings are easier for the scissors user to read along the cutting edges 20, since the user's point of view is usually beyond and above the handle end of the scissors.

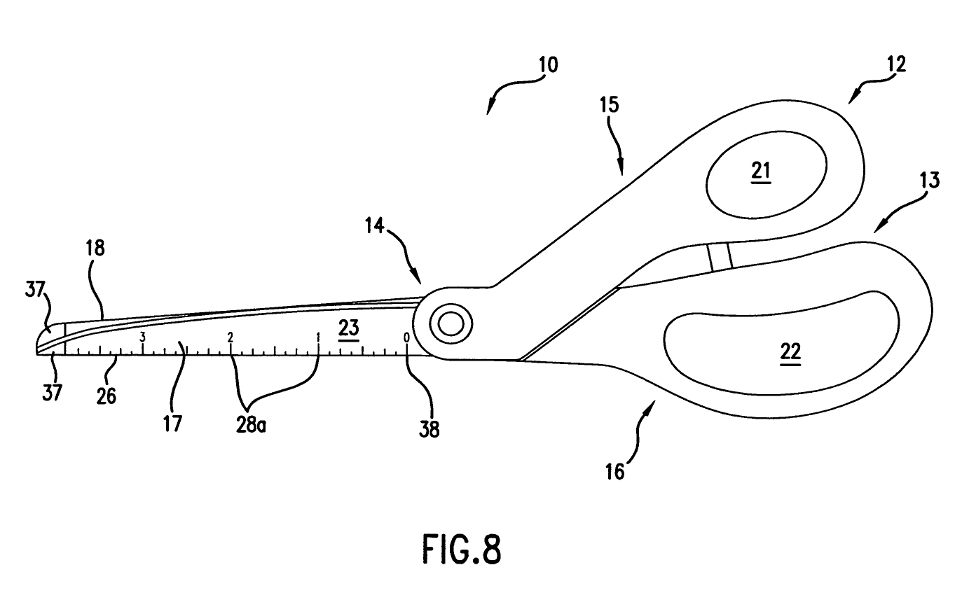

Turning to FIG. 8, the tip portions 27 of one or both blade members 17, 18 may include magnets 37. The tip magnets 37 are useful for picking up straight pins, sewing needles, small safety pins, paper clips, small screws, metal filings, and other metal materials, regardless of whether the scissors is open or closed. A tip magnet 37 can be used to extract a dropped straight pin, etc. from a crevice. Lightweight scissors 10 may also be hung by the magnetic tips 37 from a magnetized surface. The tip magnets can be adhered to the metal scissors tip portions 27 during manufacture of the scissors, or the tips themselves may be magnetized or coated with a magnetic coating.

The word “scissors” herein is meant to include shears as well as school—and kitchen—type scissors, and can be used for cutting materials 11, such as fabric, light gauge sheet metal, paper, cardboard, etc. The fulcrum 14 may include a screw, a bolt, or a rivet. No cumbersome or hard to work attachments to the measuring scissors 10, such as flexing arms or shelves, are required herein. The measuring scissors 10 are easily stored; no extra pieces are needed in order to use it.

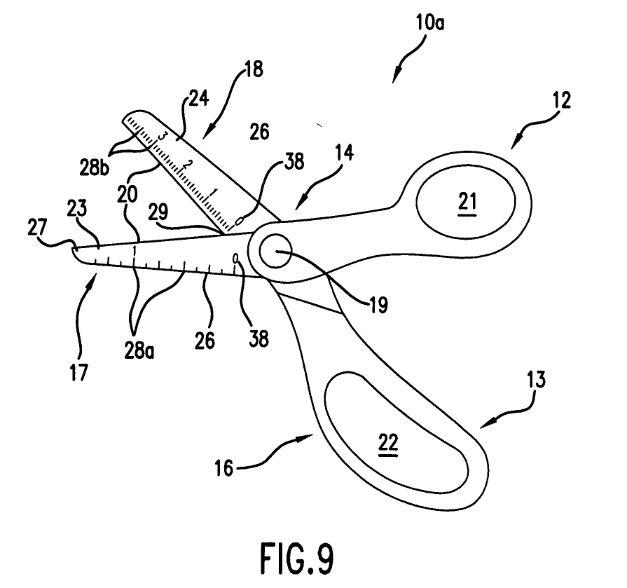

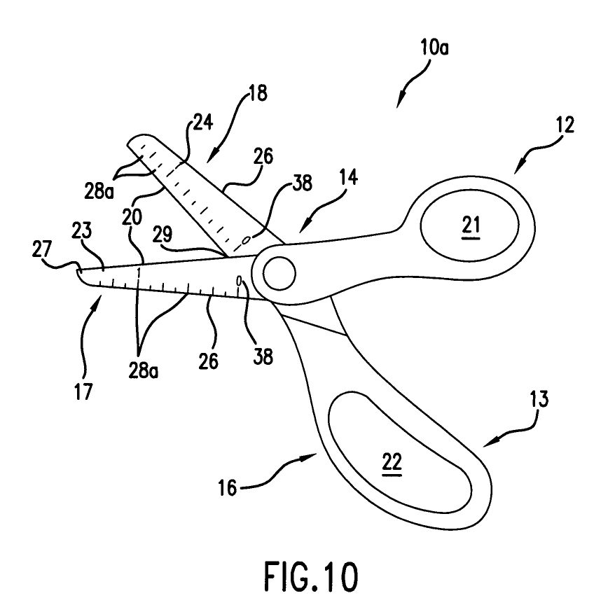

The tips 27 of the scissors blade members may be sharp as seen in FIGS. 1 and 2, or blunt and rounded as seen in FIGS. 9 and 10, as desired. FIGS. 9 and 10 show a child's safety measuring scissors 10, which is smaller than the adult scissors shown in FIGS. 1 and 2 in order to better fit into a child's hand. For safety reasons, the cutting edges 20 of the child safety scissors 10a are not as sharp as the cutting edges 20 of the adult scissors 10. The adult scissors 10 shown herein are intended for use by adults, and the child's safety scissors 10a is intended for use by elementary school age children and younger.

In the child safety scissors 10a illustrated in FIG. 9, English system length indicia 28a including numerals 0 and 1 are on the upper surface 23 of the first blade member 17. The “0” marking 38 is adjacent the end of the first handle member 15 and the fulcrum 14. Metric system indicia 28b are printed on the lower surface 24 of the second blade member 18, with “0” at the juncture 29 of the two blade members 17, 18. Metric system indicia include numerals 0, 1, 2, and 3 and dashes indicating millimeters. Since the measurements are displayed side by side on the blades, this pair of scissors 10a is an effective teaching tool, if desired, for teaching children the English system versus the metric system for measuring length. It can be seen that the measurement indicia on the lower surface 24 are set off from the cutting edge 20, and the measurement indicia on the upper surface 23 are on the substantially straight outside edge 26.

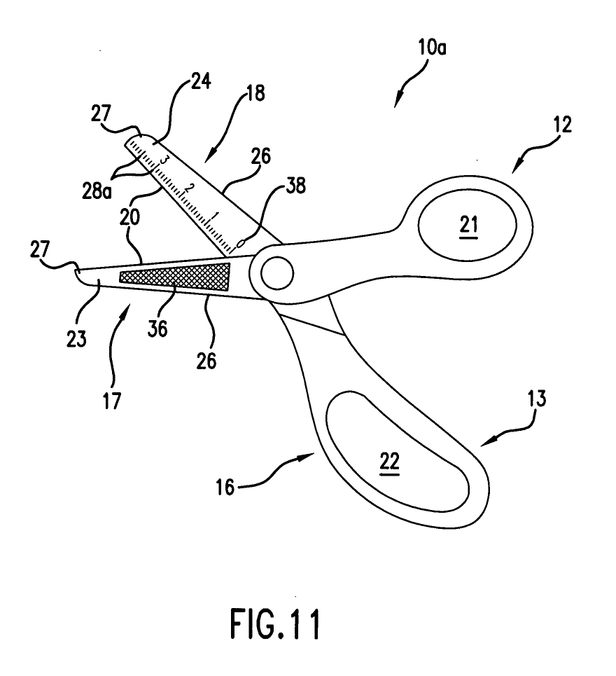

In the child safety scissors 10a illustrated in FIG. 10, similar sets of English system length indicia (between 0 and about 1½ inches) are etched on the lower surface 24 of the second blade member 18 along the cutting edge 20, and the upper surface 23 of the first blade member 17 along the outside edge 26. The “0” markings 38 are adjacent the end of the handle. Referring to FIG. 11, a flip side of the child's safety scissors 10a includes a set of metric system indicia 28b on the lower surface 24 of the first blade member 17 offset from the cutting edge 20, and a file 36 etched into the upper surface 23 in a middle area of the second blade member 18.

From the foregoing it can be realized that the described device of the present invention may be easily and conveniently utilized as measuring scissors. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 measuring scissors
11 sheet/material
12 first lever
13 second lever
14 fulcrum
15 first handle member
16 second handle member
17 first blade member
18 second blade member
19 fulcrum axis
20 cutting edge
21 first handle hole
22 second handle hole
23 upper surface of blade member
24 lower surface of blade member
25 sloped edge
26 outside edge of blade member
27 tip portion of blade member
28 measurement indicia
29 apex of cutting edges
31 notch
32 first dot
33 second dot
34 third dot
35 angle indicia
36 file
37 magnets
38 “0” marking

What is claimed is:

1. A hand-held scissors for measuring or cutting a material, the measuring scissors comprising:
(a) a pair of cooperating, cross-connected levers movably joined at a fulcrum, each lever comprising a handle member on one side of the fulcrum, and a blade member on an opposite side of the fulcrum, each blade member comprising one elongated cutting edge, the cutting edges facing one another, a first one of the substantially ring-shaped handle members comprising a first handle hole, and a second one of the handle members comprising a second handle hole, each blade member comprising a substantially planar upper surface and a substantially planar opposite, lower surface, and
(b) a set of measurement indicia permanently marked on the upper surface of at least one of the blade members, and the lower surface of at least one of the blade members.

2. The scissors according to claim 1, wherein one set of the measurement indicia is on the upper surface of a first one of the blade members, and a set of the measurement indicia is marked on the lower surface of a second one of the blade members.

3. The scissors according to claim 1, wherein each set of the measurement indicia comprises a “0” marking on the end portion of the blade member that is adjacent the fulcrum.

4. The scissors according to claim 3, further comprising a substantially semi-circular shaped turning notch adjacent the “0” marking.

5. The scissors according to claim 2, wherein one set of the measurement indicia is also marked on the upper surface of the second blade member.

6. The scissors according to claim 2, wherein the measurement indicia comprise a plurality of numerals, each numeral being substantially vertically oriented along a longitudinal axis of the blade surface.

7. The scissors according to claim 1, wherein any measurement indicia on the lower surface are set off from the cutting edge, and any measurement indicia on the upper surface of the blade member are on the outside edge of the blade member.

8. The scissors according to claim 1, further comprising at least one magnetic tip on a tip portion of the blade member.

9. The scissors according to claim 1, wherein the two levers rotate about an axis of rotation at the fulcrum, and a cutting plane of the levers is substantially perpendicular to the fulcrum axis of rotation.

10. The scissors according to claim 10, wherein the lower surfaces of the two blade members substantially overlie one another when the measuring scissors are in a closed position, an opposite, outside elongate edge of each blade member being substantially planar.

11. The scissors according to claim 2, wherein one set of measurement indicia is from the English system of measurement, and the other set of measurement indicia is from the metric system of measurement.

12. The scissors according to claim 11, wherein the sets of measurement indicia each comprise a set of numerals, each set of numerals facing in an opposite direction from a second set of numerals.

13. The scissors according to claim 1, further comprising a file on the upper surface of at least one of the blade members.

14. The scissors according to claim 1, wherein the measurement indicia comprises at least one angle marking on the lower surface of one of the blade members adjacent the cutting edge.

15. The scissors according to claim 1, wherein the scissors is a child's safety scissors comprising a rounded tip portion on an end of each blade member, one set of the measurement indicia on a first one of the blade members comprising metric system markings, a second set of measurement indicia on the second blade member comprising English system markings.

16. The scissors according to claim 15, wherein the tip portion of each blade member of the scissors is magnetic.

17. The scissors according to claim 15, wherein one set of the measurement indicia is on the lower surface of one blade member, and the other set of the measurement indicia is on the upper surface of the other blade member, each set of measurement indicia comprising a “0” marking adjacent the fulcrum.

18. The scissors according to claim 17, wherein the measurement indicia on the lower surface are set off from the cutting edge of the one blade member, and the measurement indicia on the upper surface are on the outside edge of the other blade member.

19. The scissors according to claim 15, wherein a first, metric system one of the set of the measurement indicia is on a lower surface of a first one of the blade members, a second, English system one of the set of measurement indicia is on an upper surface of a second one of the blade members, and a third one of the sets of measurement indicia is on an upper surface of the first blade member.

20. The scissors according to claim 1, wherein the scissors is a child's safety scissors comprising a rounded tip portion on an end of each blade member, and like sets of English system measurement indicia are marked on the upper surface of a first one of the blade members, and the lower surface of a second one of the blade members.
